(19) United States
(12) Patent Application Publication
(10) Pub. No.: US 2024/0391745 A1
(43) Pub. Date: Nov. 28, 2024

(54) FALL PROTECTION SYSTEMS AND METHODS

(71) Applicant: The Boeing Company, Arlington, VA (US)

(72) Inventors: Gerald Oren Pollard, Snohomish, WA (US); Alexandru Gheorghe Badger, Stanwood, WA (US); Maximilian Christopher Payne, Seattle, WA (US); Julie Francine Sweeney, Arlington, WA (US); David Anton Danner, JR., Snohomish, WA (US)

(73) Assignee: The Boeing Company, Arlington, VA (US)

(21) Appl. No.: 18/324,436

(22) Filed: May 26, 2023

(51) Int. Cl. B66F 17/00

(52) U.S. Cl. CPC B66F 17/006

(57) ABSTRACT

A system and a method include a fall protection system having safety anchors coupled with a passenger basket of a lift system and a controller including one or more processors. Each of the safety anchors is configured to receive a safety key. The controller receives data from one or more sensors and determines a number of operators that are positioned within the passenger basket based on the data. The controller can determine a number of safety keys that are operably coupled with the safety anchors, and can compare the number of safety keys that are operably coupled with safety anchors with the number of operators positioned within the passenger basket. If the number of operators is different than the number of safety keys coupled with safety anchors, one or more operations of the passenger basket are prohibited.

### FIELD OF THE DISCLOSURE

Examples of the present disclosure generally relate to personal fall protection systems and methods.

### BACKGROUND OF THE DISCLOSURE

Regulations exist that require all personnel using a lift system (e.g., a boom lift, a scissor lift, etc.) to be wearing a fall protection harness that is to be connected to the lift system so that the occupant may not fall out. For example, if the occupant falls from the lift, the fall distance is limited by a length of a safety strap that extends between the protection harness worn by the operator and the lift basket. The safety strap may have a safety key disposed at one end of the strap (that is opposite the end of the strap that is tethered to the harness of the operator) that may be coupled with one or more safety anchors of the lift basket. The safety anchors may be electrically coupled with a control system of the lift system, and a verification process may require confirmation that each safety key is securely coupled with at least one safety anchor before movement of the lift system is allowed.

However, existing verification systems fail to consider a number of occupants that are positioned within the passenger basket when determining whether movement of the passenger basket is allowed. Additionally, existing verifying systems fail to control a locking system of a gate of the lift basket. For example, an occupant positioned within an elevated lift basket may be able to open the gate of the lift basket, regardless of whether the occupant is securely anchored to the lift basket. The existing systems rely on the occupant remembering to connect their safety straps to an anchor of the lift basket. Furthermore, existing systems fail to identify and/or communicate to the occupants if the connection of the safety key to the anchor is incorrect or has failed. For example, the occupant may believe that they are securely anchored to a safety anchor of the lift basket, but the key may have become disconnected from the anchor.

### SUMMARY OF THE DISCLOSURE

A need exists for a fall protection system and method that automatically validates the safety for all occupants. Further, a need exists for a fall protection system that is able to determine a number of occupants that are positioned within a lift basket, and allow and/or prohibit operation of the lift system based on the number of occupants and the state of connection between a safety key tethered to an occupant via a safety strap and a safety anchor of the lift basket.

With those needs in mind, certain examples of the present disclosure provide a fall protection system and method that determines a number of occupants that are positioned within a passenger basket of a lift system based on data received from one or more sensors. The passenger basket also includes plural safety anchors, where each of the plural safety anchors is able to receive a safety key. The method also includes determining, by a controller of the lift system having one or more processors, a number of safety keys that are operably coupled with corresponding safety anchors, and comparing the number of occupants with the number of safety keys being used.

In one example, if the number of occupants is the same as the number of safety keys being used, then operation of the lift system and/or passenger basket of the lift system is allowed. For example, the lift system may be controlled to move the passenger basket in a vertical direction and/or a horizontal direction, a state of a locking system of a gate of the basket may be changed to an unlocked state so that the gate may allowed to be opened and closed by the occupant, etc.

Alternatively, if it is determined by the controller that the number of occupants is different than the number of safety keys operably coupled with the corresponding anchors, then operation of the lift system and/or the passenger basket of the lift system is prohibited. For example, the passenger basket may be prohibited from being moved in any direction, the state of the locking system of the gate of the passenger basket may be changed to a locked state so that an occupant of the passenger basket is prohibited from opening the gate, etc.

In at least one example, the controller receives the sensed data from the one or more sensors disposed within the passenger basket. The sensors may be referred to as occupant detector sensors and may include a position sensor, a camera (e.g., still camera, video camera, ergonomic camera, etc.), a pressure sensor, an ultrasonic sensor, a collision sensor, an infrared sensor, or the like. For example, the controller may receive the sensed data from the one or more sensors, and may determine the number of occupants that are positioned within the passenger basket of the lift system based at least in part on the sensor data.

In at least one example, the one or more processors of the controller may determine a location of each of the plural safety anchors that are operably coupled with at least one of the safety keys. For example, the controller may determine that a safety key is coupled with an interior safety anchor that is positioned within an interior region of the passenger basket. Alternatively, the controller may determine that the safety key is coupled with an exterior safety anchor that is positioned outside of a basket frame of the passenger basket. Based on the location of the safety anchor to which the safety key is coupled, different operations of the lift system may be controlled (e.g., allowed or prohibited). For example, if at least one safety key is coupled with an exterior safety anchor, then the gate locking system may be changed to an unlocked state and the occupant may be allowed to open and close the gate, but movement of the passenger basket in one or more directions (e.g., vertical, horizontal, radial, etc.) may be prohibited. As another example, if no safety key is coupled with an exterior safety anchor, then the gate locking system may remain in a locked state (e.g., the occupant may be unable to open the gate) but the passenger basket may be allowed to be controlled to move in one or more directions.

In at least one example, the processor(s) of the controller may determine that the number of safety keys operably coupled with corresponding safety anchors has changed. For example, the controller may determine that an occupant that had previously been securely tethered to a safety anchor is no longer secured to any of the safety anchors. In one example, the operator may have manually separated the safety key from the safety anchor. In another example, the connection between the safety key and the safety anchor may have failed. Responsive to the safety key being separated from the safety anchor, and the safety key not being reattached to another safety anchor, operations of the lift system may be prohibited.

In at least one example, the processor(s) of the controller may receive sensed data from the one or more sensors, and may differentiate sensed data corresponding to the occupants from other sensed data, such as data corresponding to other loads of the passenger basket.

Certain examples of the present disclosure provide a fall protection system that includes safety anchors that are operably coupled with a passenger basket. Each of the safety anchors is configured to receive a safety key. One or more operators may be positioned within the passenger basket. A controller having one or more processors receives sensed data from one or more sensors of the passenger basket and determines a number of operators that are positioned within the passenger basket. The controller compares the number of operators with a number of safety keys that are operably coupled with the safety anchors. If the number of safety keys operably coupled with corresponding safety anchors is different than the number of operators, then operation of the passenger basket and/or lift system is prohibited. Alternatively, if the number of safety keys coupled with safety anchors is the same as the number of operators, then operation of the passenger basket and/or lift system is allowed.

Certain examples of the present disclosure provide a method that includes comparing, with one or more processors, a number of occupants positioned within a passenger basket of a lift system with a number of safety keys that are operably coupled with corresponding safety anchors of the passenger basket. Responsive to determining that the number of occupants is different than the number of safety keys operably coupled with corresponding safety anchors, operation of the passenger basket is prohibited.

### BRIEF DESCRIPTION OF THE DRAWINGS

FIG. 1 illustrates an example of a lift system, according to an example of the present disclosure.

FIG. 2 illustrates a top view of a passenger basket of a lift system, according to an example of the present disclosure.

FIG. 3 illustrates a schematic of a controller of the passenger basket shown in FIG. 2, according to an example of the present disclosure.

FIG. 4 illustrates a schematic of the circuitry of components of a lift system, according to an example of the present disclosure;

FIG. 5 illustrates a partial view of a safety key operably coupled with a safety anchor of a passenger basket, according to an example of the present disclosure.

FIG. 6 illustrates a flow chart of a method, according to an example of the present disclosure.

FIG. 7A illustrates a first example of occupants positioned within a passenger basket, according to an example of the present disclosure.

FIG. 7B illustrates a second example of occupants positioned within a passenger basket, according to an example of the present disclosure.

FIG. 8 illustrates a third example of occupants positioned within a passenger basket, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

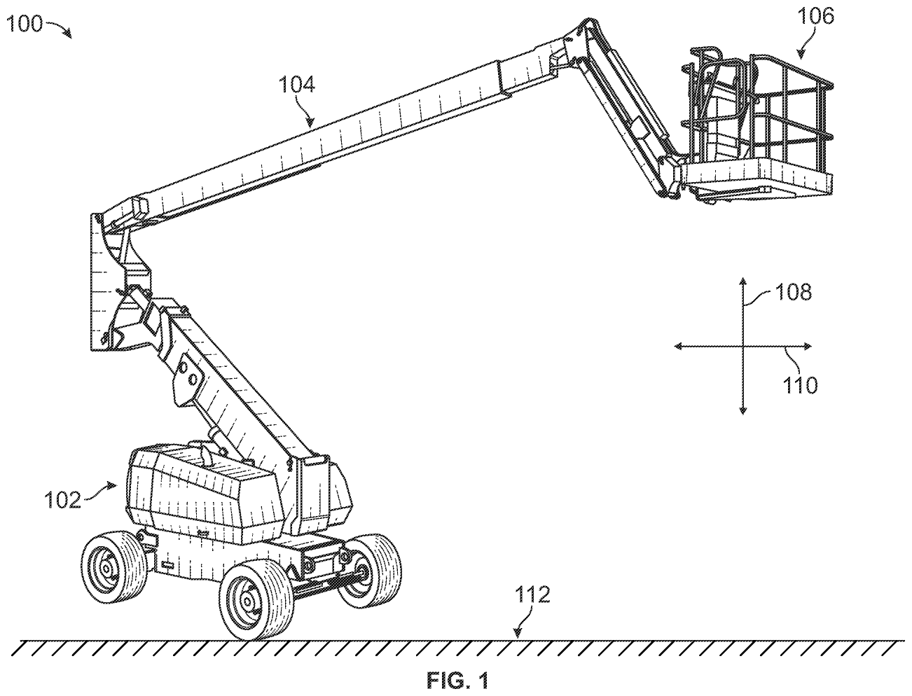

FIG. 1 illustrates a lift system 100, in accordance with one example. The lift system includes a base 102 and a passenger basket 106, with an arm 104 that extends between the base and the basket. In other examples, the lift system may be a scissor lift system, or the like, that moves occupants and/or equipment between different elevations. In the illustrated example, the lift system is a boom lift system, and the arm 104 is controlled to move the passenger basket 106 in a vertical direction 108 between a ground surface and plural different elevations, and a horizontal or lateral direction 110. Additionally, the base 102 includes wheels that can be controlled to move the lift system in the horizontal direction 110.

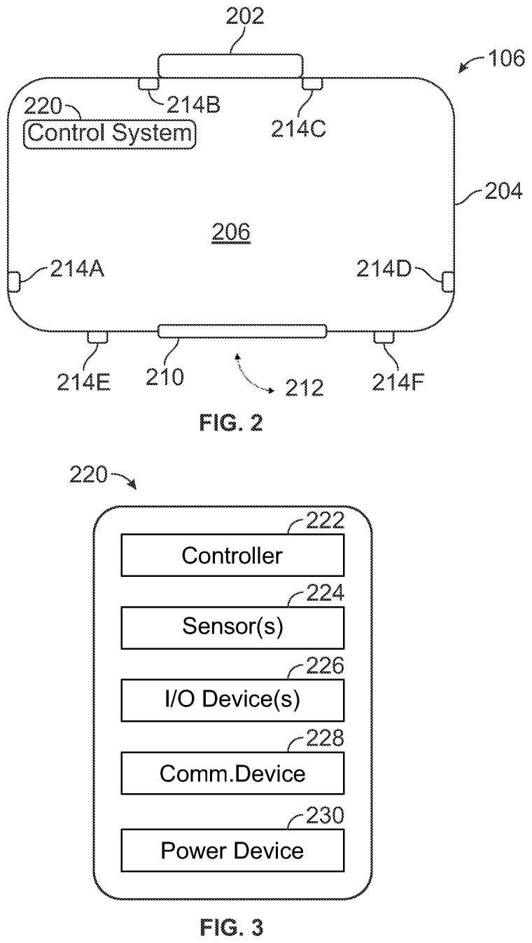

FIG. 2 illustrates a top view of the passenger basket 106, in accordance with one example. The passenger basket 106 includes a basket frame 204 that is coupled with the arm (not shown in FIG. 2) at a joint 202. The passenger basket 106 includes an interior region 206 that is inside of the basket frame. For example, one or more occupants and/or equipment may be positioned within the interior region 206 of the basket frame 204 to move the occupants and/or equipment to different elevations.

The passenger basket 106 includes a gate 210 that is arranged to move between an open position and a closed position (shown in FIG. 2) in a direction of rotation 212. In another example, the gate may have an alternative arrangement such that the gate moves in one or more different directions between the open and closed positions.

The lift system 100 also includes a control system 220. In the illustrated example, the control system is positioned within the passenger basket 106, but in alternative examples, the control system, or one or more components of the control system 220, may be disposed at other locations of the lift system, such as at the base 102.

FIG. 3 illustrates a schematic of one example of the control system 220. The control system 220 includes a controller 222 having one or more processors, such as one or more microprocessors, field programmable gate arrays, integrated circuits, and/or the like. In one example, the controller may include a single processor or multiple processors. All operations can be performed by each processor, or each processor may perform at least one different operation than one or more (or all) other processors.

The control system 220 includes and/or may be operably coupled with one or more sensors 224. In one or more examples, the one or more sensors 224 may include a position sensor, a camera (e.g., a still camera, a video camera, an ergonomic camera, etc.), a pressure sensor, an ultrasonic sensor, a collision sensor, an infrared sensor, or the like. The one or more sensors 224 may be positioned at one or more locations of the passenger basket 106, may be operably coupled with the passenger basket 106, may be disposed outside of the basket, or any combination therein. In one example, the one or more sensors may be referred to as occupant detector sensors. For example, the sensors may sense or otherwise detect data associated with occupants and/or other loads (e.g., equipment, materials, etc.) that are positioned within the passenger basket such as, but not limited to, a number of occupants that are inside the basket, a location of each of the occupants within the interior region 206 of the passenger basket 106 (e.g., relative to each other occupant, relative to the gate 210, etc.), a number of occupants that are disposed outside of the passenger basket 106 (e.g., such as an occupant that has moved outside of the basket frame 204), a location of the equipment within the basket, a weight of the other loads, a total weight of the occupants and the other loads, or the like.

The control system 220 also includes one or more input and/or output devices 226 (shown as “I/O Device(s) in FIG. 3). The lift system can be manually operated by receiving instruction signals from the input/output devices 226 that can represent a touchscreen, a joystick, a keyboard, a switch, a wheel, a microphone, a display, a monitor, a speaker, a light, or the like.

In one or more examples, the control system 220 can include a communication device 228 that represents transceiving hardware (e.g., antennas, wires, cables, modems, codecs, or the like) that can wirelessly communicate signals or communicate signals described herein via wired connections. The communication device may communicate with the one or more occupants and/or operators positioned within the passenger basket 106, with one or more operators positioned proximate to the base 102 of the lift system 100, with one or more operators at a control center (not shown), or the like.

The control system 220 also includes a power device 230, that can represent one or more batteries, fuel cells, or the like, that may provide power to one or more systems and/or components of the lift system (e.g., propulsion loads, auxiliary loads, etc.).

Returning to FIG. 2, in one or more examples, the gate 210 may be moved from a closed position to an open position, such as to allow occupants and/or equipment to move into and/or out of the interior region 206 of the passenger basket 106. In one example, prior to the passenger basket 106 leaving the ground surface, or moving away from the ground surface, the gate 210 may be moved to a closed position, such as to contain the occupants and/or equipment within the interior region 206 of the passenger basket 106. In another examples, after the passenger basket 106 has been moved to an elevated position (e.g., to perform maintenance on a structure, such as a building, an aircraft system, utility equipment, or the like), the gate 210 may be moved to an open position to allow the occupants to move out of the interior region 206 of the passenger basket 106. For example, the occupant may need to move to a portion of a structure that is being repaired that is at a location that the passenger basket is unable to reach.

The passenger basket 106 also includes plural safety anchors 214A-E that are disposed at different locations around the basket frame 204. In the illustrated example, the passenger basket 106 includes four safety anchors 214A-D that are disposed at interior locations of the basket frame 204 (e.g., within the interior region 206 of the passenger basket), and two safety anchors 214E-F that are disposed at exterior locations of the basket frame 204 (e.g., outside of the basket frame). Each of the safety anchors 214A-F may be shaped and/or sized to receive a mating component, such as a safety key, that secures or anchors the one or more occupants to the passenger basket 106. For example, a first end of a safety strap or lanyard (not shown) may be operably coupled with at least one of the occupants (e.g., attached to the occupant such as by a harness, a carabiner, or the like), and a second end of the safety strap may be operably coupled with a safety key.

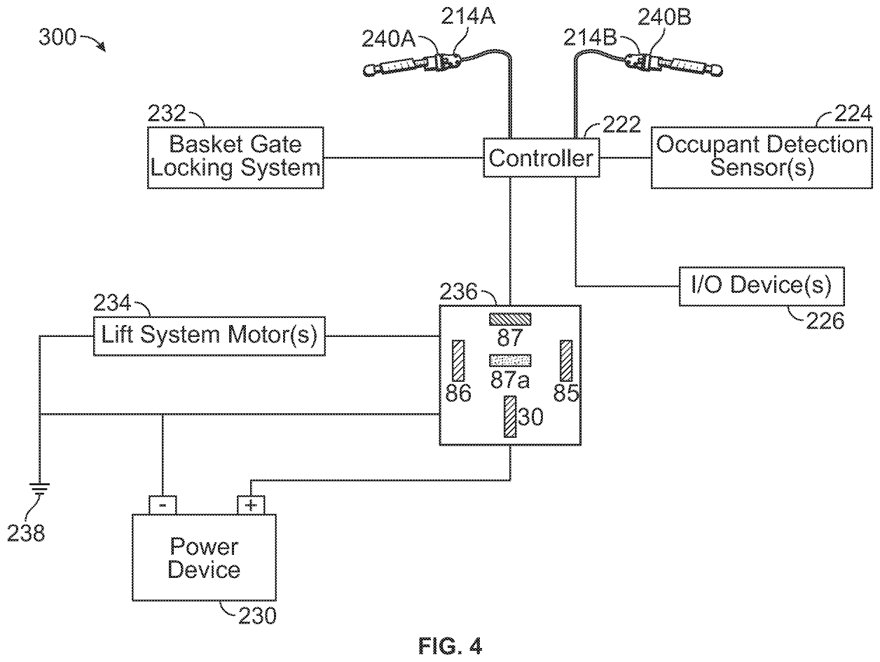

FIG. 4 illustrates a schematic of the circuitry associated with controlling operation of the passenger basket 106, and/or one or more systems or components of the passenger basket, in accordance with one example of the present disclosure. The controller 222 is electrically coupled with the input/output device(s) 226, a locking system 232 of the basket gate (e.g., an electronic and/or mechanical locking system that can control whether the gate can be opened and/or closed), the one or more sensors 224 (such as the occupant detector sensors), one or more lift system motors 234 (e.g., motors that control movement of the passenger basket and/or the base 102 of the lift system 100), and the power device 230 via a relay 236. The one or more lift system motors 234, the power device 230, and the relay 236 are also electrically coupled with an electrical ground 238. The schematic shown in FIG. 4 is for illustrative purposes only. In another example, the circuitry may have an alternative configuration, may include one or more additional electrical components, may be devoid one or more components shown, or the like.

In the illustrated example, the controller 222 is also electrically coupled with a first safety anchor 214A and a second safety anchor 214B. In other examples, the controller may be electrically coupled with three or more safety anchors of the passenger basket 106. The first safety anchor 214A is matingly coupled with a first safety key 240A, and the second safety anchor 214B is matingly coupled with a second safety key 240B.

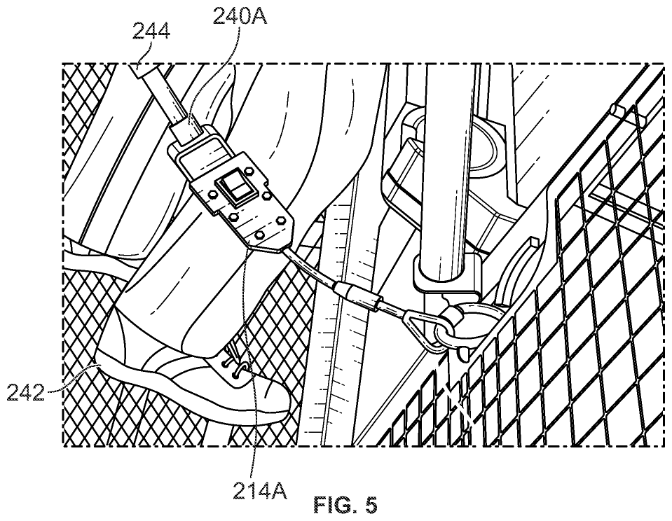

FIG. 5 illustrates a partial magnified view of the safety key 240A that is matingly coupled with the first safety anchor 214A, in accordance with one example of the present disclosure. The safety key 240A is operably coupled with a first end of a safety strap 244 or safety lanyard. A second end of the safety strap 244 may be fastened or coupled with an occupant 242 of the passenger basket 106 (not shown). While the occupant or operator is anchored to the safety anchor of the passenger basket 106 via the safety key 240A, the safety of the occupant increases relative to the occupant not being secured or tethered to the safety anchor via the safety key.

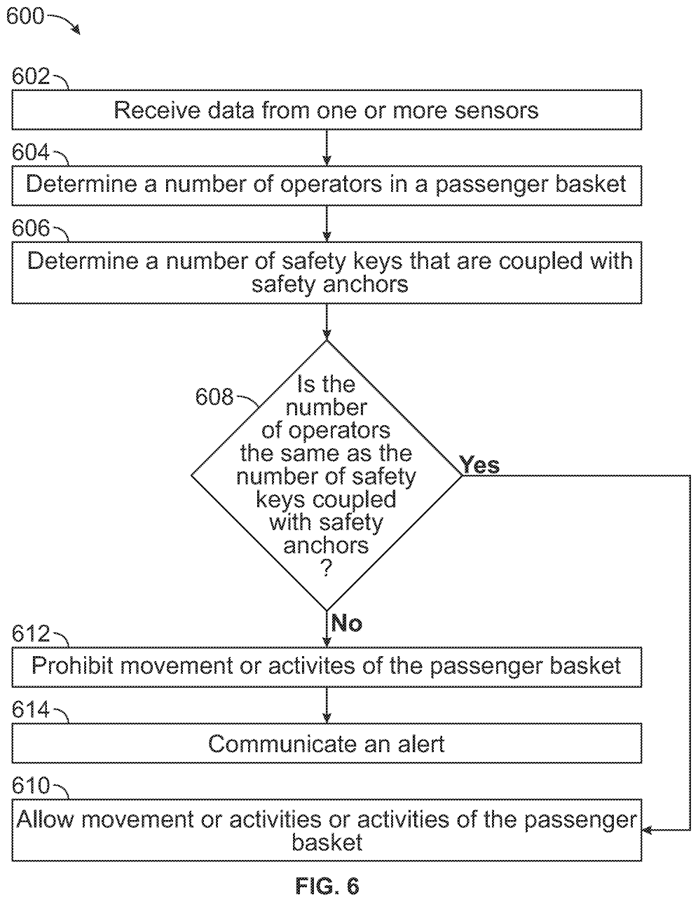

FIG. 6 illustrates a flow chart 600 of a method, such as for controlling operation of a passenger basket of a lift system, in accordance with one example of the present disclosure. The method includes receiving data 602, by a controller 222 including one or more processors, from one or more sensors 224. The controller can determine 604 a number of operators or occupants that are disposed or positioned within a passenger basket of a lift system based at least in part on the sensor data. The controller can also determine 606 a number of safety keys that are operably coupled with corresponding safety anchors of the passenger basket. As one example, each of the safety anchors may be arranged to receive a single safety key. In another example, one or more safety anchors may be arranged to be able to receive two or more different safety keys.

The method also includes comparing the number of operators that are positioned within the passenger basket with the number of safety keys that are coupled with corresponding safety anchors, and determining 608, by the controller 222, if the number of operators is the same as the number of safety keys. If the number of operators is the same as the number of safety keys, then the method proceeds to 610, and movement or operations of the passenger basket are allowed. For example, if the controller determines that there are two occupants positioned in the passenger basket, and there are two safety keys that are coupled with corresponding safety anchors, then the controller may be able to raise the passenger basket away from a surface, lower the passenger basket towards the surface or towards a lower elevation, move the passenger basket in a lateral or horizontal direction, allow the gate of the basket to be opened (e.g., change the state of the basket gate locking system 232 shown in FIG. 4 to an unlocked state to allow an operator to open and/or close the gate), or the like.

Alternatively, if the controller 222 determines that the number of operators is different than the number of safety keys, then the method proceeds to 612, and movement or operations of the passenger basket are prohibited. For example, if the controller determines that there are two occupants positioned in the passenger basket, but only one safety key is coupled with a corresponding safety anchor, then the controller may prohibit the passenger basket from being raised or lowered to different elevations, may prohibit the gate of the basket from being opened (e.g., the state of the basket gate locking system 232 may be in a locked state and the operator may be unable to open the gate), or the like. In one example, an alert may be communicated 614, such as by the communication device 228. The alert may be an audio, visual, and/or physical alert that is communicated to the occupants of the passenger basket. Optionally, an alert may be wirelessly communicated to a control center, such as to notify one or more operators at the control center that the occupants of the passenger basket are not properly anchored to the passenger basket.

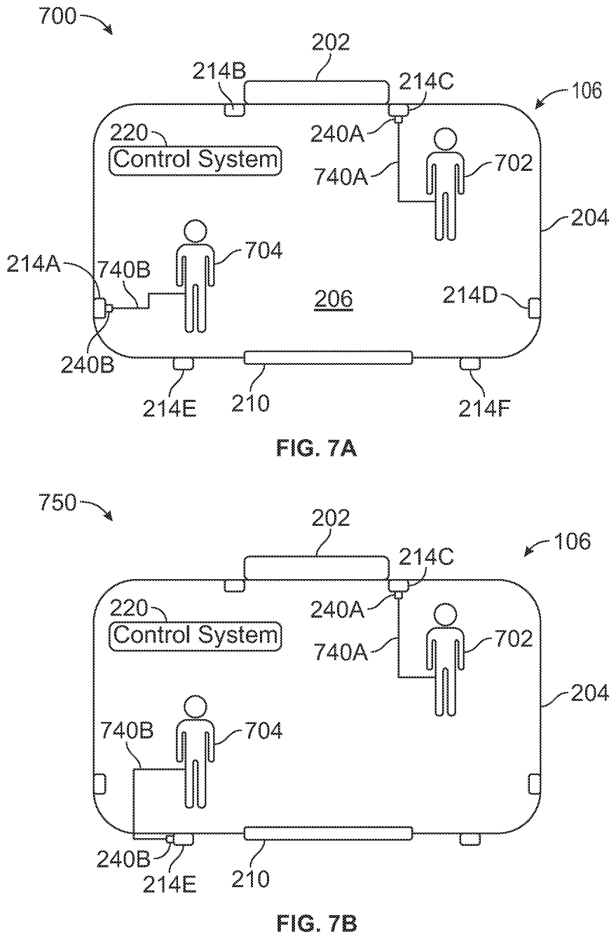

In one example, the controller 222 may identify a location of each of the safety anchors that are operably coupled with at least one safety key, and may prohibit or allow movement of the passenger basket responsive to determining the location of the safety anchors that are in use. For example, FIG. 7A illustrates a first example 700 of occupants of a passenger basket 106, according to an example of the present disclosure. A first occupant 702 and a second occupant 704 are positioned within the passenger basket 106 of the lift system. The first occupant 702 is tethered to a first safety strap 740A that extends between a first end that is coupled with the first occupant and a second end that is coupled with the first safety key 240A. In the illustrated example, the first occupant 702 is securely anchored to the third safety anchor 214C via the first safety key 240A. Additionally, the second occupant 704 is tethered to a second safety strap 740B that extends between a first end that is coupled with the second occupant and a second end that is coupled with the second safety key 240A. The second occupant is securely anchored to the first safety anchor 214A via the second safety key 240B.

The control system 220 may identify that there are two occupants positioned within the passenger basket 106 (e.g., the first and second occupants 702, 704), and that there are two safety keys that are operably coupled with two corresponding safety anchors (e.g., the first and third interior safety anchors 214A, 214C). Based on the number of occupants being the same as the number of safety keys being coupled with safety anchors, movement of the passenger basket may be allowed.

In one example, the controller 222 of the control system 220 may identify the location of the safety anchors to which the first and second occupants 702, 704 are anchored, and may allow and/or control movement of the passenger basket 106 based on the location of the safety anchors that are being used. For example, the controller may identify that the first and third safety anchors 214A, 214C are interior anchors. Responsive to determining that the first and third safety anchors 214A, 214C are interior safety anchors, the controller may be allowed to raise and/or lower the passenger basket 106, but the controller may control the gate 210 to be in a locked state.

In an alternative example, FIG. 7B illustrates a second example 750 of occupants positioned within the passenger basket 106. The first occupant 702 is secured to the third safety anchor 214C via the first safety key 240A, and the second occupant 704 is secured to the fifth safety anchor 214E via the second safety key 240B. For example, the controller 222 may identify that the first occupant 702 is securely anchored to an interior safety anchor (e.g., 214C), and the second occupant 704 is securely anchored to an exterior safety anchor (e.g., 214E). Responsive to determining that the second occupant 704 is secured to the exterior safety anchor, the controller may be allowed to change the locking state of the gate 210 from a locked state to an unlocked state. For example, the gate 210 may be unlocked, and the first and/or second occupants 702, 704 may be allowed to open and close the gate 210 of the passenger basket 106. In one example, while the gate is in the unlocked state, the controller may prohibit other movement of the passenger basket 106. For example, the controller may prohibit one of the occupants from controlling the lift system motors 234 (shown in FIG. 4) to raise or lower the passenger basket 106 while the gate 210 is in the unlocked state.

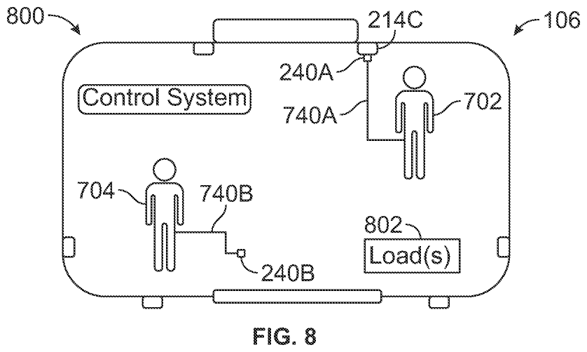

In the illustrated embodiments of FIGS. 7A and 7B, the number of occupants positioned within the passenger basket matches or is the same as the number of safety keys that are operably coupled with corresponding safety anchors. For example, the first and second occupants 702, 704 in the first and second examples 700, 750 are correctly anchored to the passenger basket 106. In another example, FIG. 8 illustrates a third example 800 of occupants positioned within the passenger basket 106, according to an example of the present disclosure. In the illustrated example, the first occupant 702 is secured to the third safety anchor 214C via the first safety key 240A. The second occupant 704, however, is not secured to any of the other safety anchors. The controller 222 may determine that the number of occupants (e.g., two) is different than the number of safety keys that are coupled with safety anchors (e.g., one), and may prohibit movement or other operations of the passenger basket 106 and/or the lift system 100. For example, the gate 210 may remain and/or be changed to be in the locked state, and the occupants may be unable to open the gate, the occupants may be unable to control the lift motors to move the passenger basket (e.g., in vertical and/or horizontal directions) and/or move the base 102 of the lift system 100, or the like.

In one or more examples, the controller 222 may continuously monitor the number of occupants and the number of safety keys that are being used while the lift system 100 is in use. For example, the controller may allow the passenger basket to be moved away from the ground surface responsive to determining that the number of occupants is the same as the number of safety keys coupled with corresponding safety anchors. Additionally, the controller may determine that the number of safety keys that are being used has changed. In one example, after the passenger basket 106 has been raised to an elevation and vertical movement of the passenger basket 106 has stopped, the controller may identify that the second occupant 704 has disconnected the second safety key 240B from the first safety anchor 214A, but has not connected the second safety key 240B to any of the safety anchors. In one example, the second occupant 704 may have manually separated the second safety key 240B from the first safety anchor 214A and may have forgotten to attach the second safety key 240B to a different safety anchor. In another example, the connection between the second safety key 240B and the first safety anchor 214A may have failed. For example, one or more components of the safety key and/or the safety anchor may have failed or otherwise compromised the connection between the key and the anchor. The controller may communicate an alert to the occupants of the passenger basket 106 indicating that one of the occupants is not securely anchored to the passenger basket 106, and may prohibit any movement or operations of the passenger basket 106 until the second occupant 704 is secured anchored to one of the safety anchors.

In one or more examples, the controller 222 may receive the sensed data from the one or more sensors 224 of the passenger basket 106. The data may include data associated with the occupants of the passenger basket 106 and one or more loads 802 that are positioned within the passenger basket. In one example, the loads may be equipment and/or materials that may be used by the occupants, such as to repair a structure or system. The controller may differentiate the data corresponding to the occupants (and number of occupants) from the data corresponding to the one or more loads 802. For example, the controller may differentiate or separate the data associated with the occupants from the data associated with the loads, and may allow or prohibit movement or operation of the passenger basket (or lift system) based on the data corresponding to the occupants (and not the data corresponding to the loads).

Further, the disclosure comprises examples according to the following clauses:

Clause 1: a method, comprising:
determining a number of operators positioned within a passenger basket of a lift system based on data received from one or more sensors, the passenger basket comprising plural safety anchors, wherein each of the plural safety anchors is configured to receive a safety key;
determining a number of safety keys that are operably coupled with the plural safety anchors;
comparing the number of operators that are positioned within the passenger basket with the number of safety keys that are operably coupled with the plural safety anchors; and
prohibiting one or more operations of the passenger basket responsive to determining that the number of operators positioned within the passenger basket is different than the number of safety keys that are operably coupled with the plural safety anchors.

Clause 2: the method of claim 1, wherein the plural safety anchors includes one or more interior safety anchors that are disposed on an interior portion of the passenger basket and one or more exterior safety anchors that are disposed on an exterior portion of the passenger basket.

Clause 3: the method of clauses 1 or 2, further comprising:
identifying a location of each of the plural safety anchors that are operably coupled with at least one of the safety keys; and
controlling the one or more operations of the passenger basket responsive to determining the location of each of the plural safety anchors.

Clause 4: the method of clauses 1-3, wherein the one or more operations of the passenger basket includes one or more of moving the passenger basket in a vertical direction between plural different elevations, moving the passenger basket in a lateral direction, or changing a state of a locking system of a gate of the passenger basket to an unlocked state.

Clause 5: the method of clauses 1-4, further comprising communicating an alert responsive to determining that the number of operators positioned within the passenger basket is different than the number of safety keys that are operably coupled with the plural safety anchors.

Clause 6: the method of clauses 1-5, further comprising allowing the one or more operations of the passenger basket responsive to determining that the number of operators positioned within the passenger basket is the same as the number of safety keys that are operably coupled with the plural safety anchors of the passenger basket.

Clause 7: the method of clause 6, further comprising:
identifying that the number of safety keys operably coupled with the safety anchors has changed;
determining that the number of operators positioned within the passenger basket is different than the number of safety keys operably coupled with the plural safety anchors of the passenger basket; and
prohibiting the one or more operations of the passenger basket responsive to determining that the number of operators positioned within the passenger basket is different than the number of safety keys that are operably coupled with the plural safety anchors.

Clause 8: the method of clauses 1-7, further comprising:
identifying one or more loads positioned within the passenger basket based at least in part on the data received from the one or more sensors; and
differentiating the one or more loads from the number of operators positioned within the passenger basket.

Clause 9: a fall protection system, comprising:
safety anchors operably coupled with a passenger basket of a lift system, each of the safety anchors configured to receive a safety key, one or more operators configured to be positioned within the passenger basket; and
a controlling including one or more processors configured to receive data from one or more sensors, the controller configured to determine a number of operators positioned within the passenger basket based on the data received from the one or more sensors,
wherein the controller is configured to compare the number of operators positioned within the passenger basket with a number of safety keys that are operably coupled with the safety anchors, and
wherein the controller is configured to prohibit one or more operations of the passenger basket responsive to determining that the number of operators positioned within the passenger basket is different than the number of safety keys that are operably coupled with the safety anchors.

Clause 10: the fall protection system of clause 9, wherein the passenger basket is configured to be controlled to move between plural different elevations to move the one or more operators between the plural different elevations.

Clause 11: the fall protection system of clauses 9 or 10, wherein the controlled is configured to control a communication device to communicate an alert responsive to determining that the number of operators positioned within the passenger basket is different than the number of safety keys operably coupled with the safety anchors.

Clause 12: the fall protection system of clauses 9-11, wherein the controller is configured to allow the one or more operations of the passenger basket responsive to determining that the number of operators positioned within the passenger basket is the same as the number of safety keys that are operably coupled with the safety anchors.

Clause 13: the fall protection system of clauses 9-12, wherein the one or more operations of the passenger basket includes one or more of moving the passenger basket in a vertical direction between plural different elevations, moving the passenger basket in a lateral direction, or changing a state of a locking system of a gate of the passenger basket to an unlocked state.

Clause 14: the fall protection system of clauses 9-13, wherein the one or more sensors includes one or more of a position sensor, a camera, a pressure sensor, an ultrasonic sensor, a collision sensor, or an infrared sensor.

Clause 15: the fall protection system of clauses 9-14, wherein the one or more sensors are operably coupled with the passenger basket.

Clause 16: the fall protection system of clauses 9-15, wherein the controller is configured to identify one or more loads positioned within the passenger basket based at least in part on the data received from the one or more sensors, wherein the controller is configured to differentiate the one or more loads from the number of operators positioned within the passenger basket.

Clause 17: a method, comprising:
comparing, with one or more processors, a number of occupants positioned within a passenger basket of a lift system with a number of safety keys that are operably coupled with corresponding safety anchors of the passenger basket; and
prohibiting one or more operations of the passenger basket responsive to determining that the number of occupants is different than the number of safety keys that are operably coupled with the corresponding safety anchors.

Clause 18: the method of clause 17, wherein the one or more operations of the passenger basket includes one or more of moving the passenger basket in a vertical direction between plural different elevations, moving the passenger basket in a lateral direction, or changing a state of a locking system of a gate of the passenger basket to an unlocked state.

Clause 19: the method of clauses 17 or 18, further comprising communicating an alert responsive to determining that the number of occupants positioned within the passenger basket is different than the number of safety keys that are operably coupled with the at least one of the safety anchors.

Clause 20: the method of clauses 17-19, further comprising:
identifying a location of each of the safety anchors that are operably coupled with at least one of the safety keys; and
controlling the one or more operations of the passenger basket responsive to determining the location of each of the safety anchors.

As described herein, examples of the present disclosure provide systems and methods for moving safety rail systems between loaded positions and unloaded positions, such as to provide safety to operators standing on an elevated platform, to allow movement of items (e.g., equipment, systems, or the like) over the stationary platform, to allow movement of the elevated platform from one location to another without interfering with a structure (e.g., an airplane or any other structure).

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A method, comprising:
determining a number of operators positioned within a passenger basket of a lift system based on data received from one or more sensors, the passenger basket comprising plural safety anchors, wherein each of the plural safety anchors is configured to receive a safety key;
determining a number of safety keys that are operably coupled with the plural safety anchors;
comparing the number of operators that are positioned within the passenger basket with the number of safety keys that are operably coupled with the plural safety anchors; and
prohibiting one or more operations of the passenger basket responsive to determining that the number of operators positioned within the passenger basket is different than the number of safety keys that are operably coupled with the plural safety anchors.

2. The method of claim 1, wherein the plural safety anchors includes one or more interior safety anchors that are disposed on an interior portion of the passenger basket and one or more exterior safety anchors that are disposed on an exterior portion of the passenger basket.

3. The method of claim 1, further comprising:
identifying a location of each of the plural safety anchors that are operably coupled with at least one of the safety keys; and
controlling the one or more operations of the passenger basket responsive to determining the location of each of the plural safety anchors that are operably coupled with the at least one of the safety keys.

4. The method of claim 1, wherein the one or more operations of the passenger basket includes one or more of moving the passenger basket in a vertical direction between plural different elevations, moving the passenger basket in a lateral direction, or changing a state of a locking system of a gate of the passenger basket to an unlocked state.

5. The method of claim 1, further comprising communicating an alert responsive to determining that the number of operators positioned within the passenger basket is different than the number of safety keys that are operably coupled with the plural safety anchors.

6. The method of claim 1, further comprising allowing the one or more operations of the passenger basket responsive to determining that the number of operators positioned within the passenger basket is the same as the number of safety keys that are operably coupled with the plural safety anchors of the passenger basket.

7. The method of claim 6, further comprising:
identifying that the number of safety keys operably coupled with the safety anchors has changed;
determining that the number of operators positioned within the passenger basket is different than the number of safety keys operably coupled with the plural safety anchors of the passenger basket; and
prohibiting the one or more operations of the passenger basket responsive to determining that the number of operators positioned within the passenger basket is different than the number of safety keys that are operably coupled with the plural safety anchors.

8. The method of claim 1, further comprising:
identifying one or more loads positioned within the passenger basket based at least in part on the data received from the one or more sensors; and
differentiating the one or more loads from the number of operators positioned within the passenger basket.

9. A fall protection system, comprising:
safety anchors operably coupled with a passenger basket of a lift system, each of the safety anchors configured to receive a safety key, one or more operators configured to be positioned within the passenger basket; and
a controller including one or more processors configured to receive data from one or more sensors, the controller configured to determine a number of operators positioned within the passenger basket based on the data received from the one or more sensors,
wherein the controller is configured to compare the number of operators that are positioned within the passenger basket with a number of safety keys that are operably coupled with the safety anchors, and
wherein the controller is configured to prohibit one or more operations of the passenger basket responsive to determining that the number of operators positioned within the passenger basket is different than the number of safety keys that are operably coupled with the safety anchors.

10. The fall protection system of claim 9, wherein the passenger basket is configured to be controlled to move between plural different elevations to move the one or more operators between the plural different elevations.

11. The fall protection system of claim 9, wherein the controller is configured to control a communication device to communicate an alert responsive to determining that the number of operators positioned within the passenger basket is different than the number of safety keys that are operably coupled with the safety anchors.

12. The fall protection system of claim 9, wherein the controller is configured to allow the one or more operations of the passenger basket responsive to determining that the number of operators positioned within the passenger basket is the same as the number of safety keys that are operably coupled with the safety anchors.

13. The fall protection system of claim 9, wherein the one or more operations of the passenger basket includes one or more of moving the passenger basket in a vertical direction between plural different elevations, moving the passenger basket in a lateral direction, or changing a state of a locking system of a gate of the passenger basket to an unlocked state.

14. The fall protection system of claim 9, wherein the one or more sensors includes one or more of a position sensor, a camera, a pressure sensor, an ultrasonic sensor, a collision sensor, or an infrared sensor.

15. The fall protection system of claim 9, wherein the one or more sensors are operably coupled with the passenger basket.

16. The fall protection system of claim 9, wherein the controller is configured to identify one or more loads positioned within the passenger basket based at least in part on the data received from the one or more sensors, and the controller is configured to differentiate the one or more loads from the number of operators positioned within the passenger basket.

17. A method, comprising:
comparing, with one or more processors, a number of occupants positioned within a passenger basket of a lift system with a number of safety keys that are operably coupled with corresponding safety anchors of the passenger basket; and
prohibiting one or more operations of the passenger basket responsive to determining that the number of occupants is different than the number of safety keys that are operably coupled with at least one of the safety anchors.

18. The method of claim 17, wherein the one or more operations of the passenger basket includes one or more of moving the passenger basket in a vertical direction between plural different elevations, moving the passenger basket in a lateral direction, or changing a state of a locking system of a gate of the passenger basket to an unlocked state.

19. The method of claim 17, further comprising communicating an alert responsive to determining that the number of occupants positioned within the passenger basket is different than the number of safety keys that are operably coupled with the corresponding safety anchors.

20. The method of claim 17, further comprising:
identifying a location of each of the safety anchors that are operably coupled with at least one of the safety keys; and
controlling the one or more operations of the passenger basket responsive to determining the location of each of the safety anchors.
